(19) United States
(12) Patent Application Publication
(10) Pub. No.: US 2025/0104898 A1
(43) Pub. Date: Mar. 27, 2025

(54) COIL COMPONENT

(71) Applicant: TDK Corporation, Tokyo (JP)

(72) Inventors: Akira MOTOHASHI, Tokyo (JP); Naoaki FUJII, Tokyo (JP); Tomonaga NISHIKAWA, Tokyo (JP); Hiroki NAKAGOMI, Tokyo (JP); Takuya TAKEUCHI, Tokyo (JP)

(21) Appl. No.: 18/891,123

(22) Filed: Sep. 20, 2024

(30) Foreign Application Priority Data
Sep. 22, 2023 (JP) 2023-157447

(51) Int. Cl. H01F 17/04; H01F 5/04; H01F 5/06

(52) U.S. Cl. CPC H01F 17/04; H01F 5/04; H01F 5/06; H01F 2017/048

(57) ABSTRACT

Disclosed herein is a coil component that includes plural conductor layers embedded in the magnetic element body. Each of the conductor layers includes a coil pattern, and first and second connection patterns exposed from the magnetic element body. The conductor layers includes a first conductor layer positioned at one end portion in the stacking direction, a second conductor layer positioned at the other end portion in the stacking direction, and one or more third conductor layers positioned between the first and second conductor layers. In the second conductor layer, an outer peripheral end of the coil pattern is connected to the second connection pattern through a lead-out pattern. In at least one of the first to third conductor layers, the magnetic element body is disposed in a separation area overlapping the lead-out pattern in the stacking direction.

### CROSS-REFERENCE TO RELATED APPLICATION

This application claims the benefit of Japanese Patent Application No. 2023-157447, filed on Sep. 22, 2023, the entire disclosure of which is incorporated by reference herein.

### BACKGROUND OF THE ART

### Field of the Art

The present disclosure relates to a coil component and, more particularly, to a coil component having a structure in which a plurality of conductor layers stacked through an insulating resin layer are embedded in a magnetic element body.

### Description of Related Art

JP 2022-152043A discloses a coil component having a structure in which a plurality of conductor layers stacked through an insulating resin layer are embedded in a magnetic element body. In the coil component disclosed in JP 2022-152043A, each conductor layer includes a coil pattern and a pair of connection patterns exposed from the magnetic element body.

To increase the inductance of the coil component, it is effective to increase the volume of the magnetic element body.

### SUMMARY

The present disclosure describes a technology for increasing the inductance of a coil component having a structure in which a plurality of conductor layers stacked through an insulating resin layer are embedded in a magnetic element body by increasing the volume of the magnetic element body.

A coil component according to one aspect of the present disclosure includes: a magnetic element body having a mounting surface and a plurality of conductor layers embedded in the magnetic element body and stacked through insulating resin layers. The plurality of conductor layers each include a coil pattern having a coil axis extending in parallel to the mounting surface and first and second connection patterns exposed from the magnetic element body. The first connection patterns included in the plurality of respective conductor layers overlap one another in a plan view as viewed in the stacking direction, and the second connection patterns included in the plurality of respective conductor layers overlap one another in a plan view as viewed in the stacking direction. The plurality of conductor layers includes a first conductor layer positioned at one end portion in the stacking direction, a second conductor layer positioned at the other end portion in the stacking direction, and one or more third conductor layers positioned between the first and second conductor layers. In the first conductor layer, the outer peripheral end of the coil pattern is connected to the first connection pattern, and the second connection pattern is separated from the coil pattern in the same surface. In the second conductor layer, the outer peripheral end of the coil pattern is connected to the second connection pattern through a lead-out pattern, and the first connection pattern is separated from the coil pattern in the same surface. In the third conductor layer, both the first and second patterns are separated from the coil pattern in the same surface. In at least one of the first to third conductor layers, the magnetic element body is disposed in a separation area overlapping the lead-out pattern in a plan view as viewed in the stacking direction.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view illustrating the outer appearance of a coil component 100 according to an embodiment of the present disclosure;

FIG. 2 is a schematic plan view for explaining the structures of the conductor layers L1 to L6;

FIGS. 3A to 3C are schematic cross-sectional views taken along the lines A-A, B-B, and C-C, respectively; and

FIG. 4 is a schematic perspective view illustrating the outer appearance of a coil component 100A according to a modification.

### DETAILED DESCRIPTION OF THE EMBODIMENTS

Some embodiments of the present disclosure will be explained below in detail with reference to the accompanying drawings.

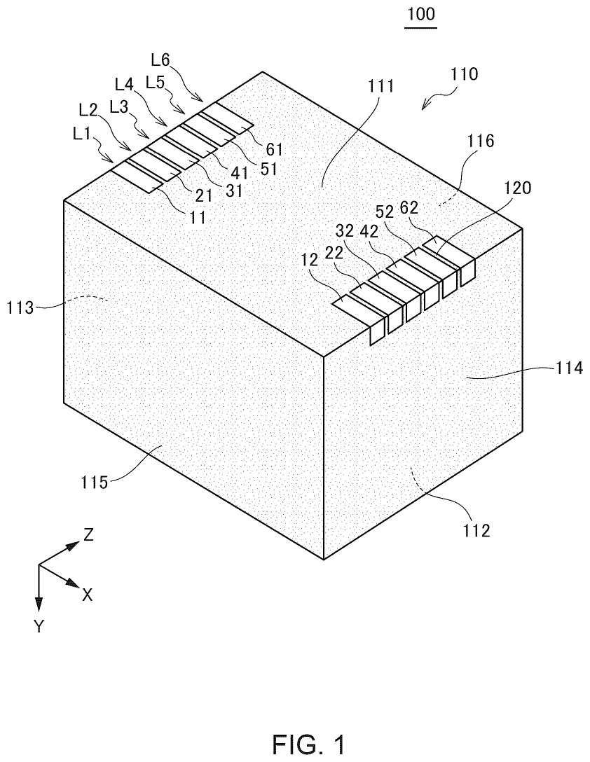

FIG. 1 is a schematic perspective view illustrating the outer appearance of a coil component 100 according to an embodiment of the present disclosure.

As illustrated in FIG. 1, the coil component 100 according to the present embodiment includes a magnetic element body 110 made of a composite material containing magnetic fillers made of a metal magnetic body and a resin binder and a plurality of conductor layers L1 to L6 embedded in the magnetic element body 110 and stacked through an insulating resin layer 120. Conductor patterns respectively provided in the conductor layers L1 to L6 and the magnetic element body 110 are insulated from each other by the insulating resin layer 120. The conductor patterns of the respective conductor layers L1 to L6 are made of a good conductor such as Cu (copper). The insulating resin layer 120 is made of non-magnetic insulating resin.

The coil component 100 according to the present embodiment is an embedded type coil component having a structure in which the insulating resin layer 120 and conductor layers L1 to L6 are embedded in the magnetic element body 110 and differs in structure from a stacked type coil component having a magnetic sheet made of a ceramic material and a coil pattern which are alternately stacked. For example, in the stacked type coil component, a magnetic sheet is interposed between coil patterns adjacent in the stacking direction; on the other hand, in the coil component 100 according to the present embodiment, coil patterns adjacent in the stacking direction are insulated by the insulating resin layer 120, and the magnetic element body 110 is not interposed therebetween. The coil component 100 according to the present embodiment also differs in structure from a sheet coil of a type having a coil pattern on a printed board.

The magnetic element body 110 has surfaces 111 and 112 constituting the XZ surface and positioned on the opposite sides to each other, surfaces 113 and 114 constituting the YZ surface and positioned on opposite sides to each other, and surfaces 115 and 116 constituting the XY surface and positioned on the opposite sides to each other. The surface 111 constitutes a mounting surface facing the surface of a circuit board in the actual use. The Z-direction is the stacking direction of the conductor layers L1 to L6. That is, in the coil component 100 according to the present embodiment, the mounting surface is parallel to the stacking direction.

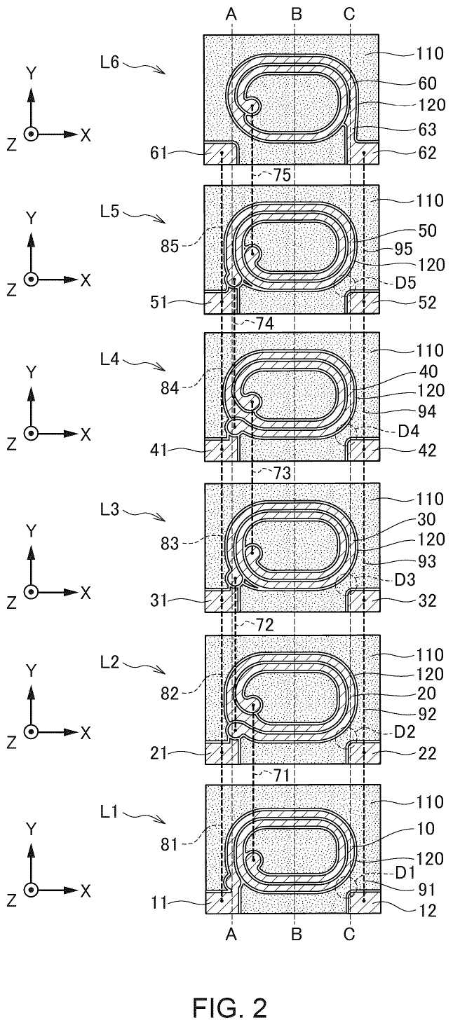

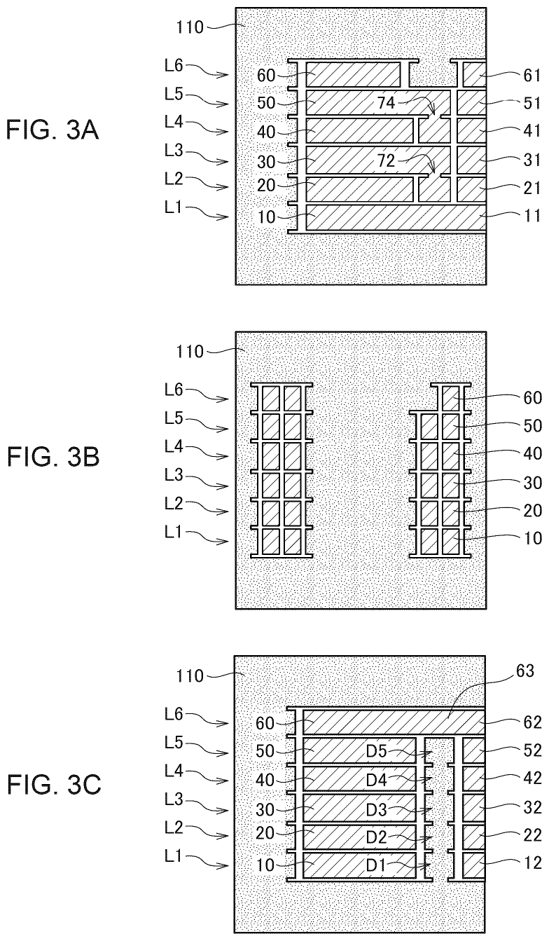

FIG. 2 is a schematic plan view for explaining the structures of the conductor layers L1 to L6. FIGS. 3A to 3C are schematic cross-sectional views taken along the lines A-A, B-B, and C-C, respectively.

As illustrated in FIG. 2 and FIGS. 3A to 3C, the conductor layer L1 has a coil pattern 10 and connection patterns 11 and 12. The magnetic element body 110 is disposed, through the insulating resin layer 120, in the inner diameter area (area surrounded by the coil pattern 10) of the coil pattern 10 and the outside area (area positioned radially outside the coil pattern 10) of the coil pattern 10. The coil pattern 10 is wound in about two turns, and adjacent turns thereof are insulated by the insulating resin layer 120. The outer peripheral end of the coil pattern 10 is connected to the connection pattern 11. The connection pattern 12 is not connected to the coil pattern 10 in the same surface and independent therein. The coil pattern 10 and connection pattern 12 are separated from each other not only through the insulating resin layer 120 but also through the magnetic element body 110. In the conductor layer L1, a part of the magnetic element body 110 that separates the coil pattern 10 and the connection pattern 12 constitutes a separation area D1.

The conductor layer L2 has a coil pattern 20 and connection patterns 21 and 22. The magnetic element body 110 is disposed, through the insulating resin layer 120, in the inner diameter area (area surrounded by the coil pattern 20) of the coil pattern 20 and the outside area (area positioned radially outside the coil pattern 20) of the coil pattern 20. The coil pattern 20 is wound in about two turns, and adjacent turns thereof are insulated by the insulating resin layer 120. The inner peripheral end of the coil pattern 20 is connected to the inner peripheral end of the coil pattern 10 through a via hole 71 formed in the insulating resin layer 120. The connection patterns 21 and 22 are not connected to the coil pattern 20 in the same surface and independent therein and respectively connected to the connection patterns 11 and 12 through via holes 81 and 91 formed in the insulating resin layer 120. The coil pattern 20 and connection pattern 21 are separated from each other through the insulating resin layer 120. On the other hand, the coil pattern 20 and connection pattern 22 are separated from each other not only through the insulating resin layer 120 but also through the magnetic element body 110. In the conductor layer L2, a part of the magnetic element body 110 that separates the coil pattern 20 and the connection pattern 22 constitutes a separation area D2.

The conductor layer L3 has a coil pattern 30 and connection patterns 31 and 32. The magnetic element body 110 is disposed, through the insulating resin layer 120, in the inner diameter area (area surrounded by the coil pattern 30) of the coil pattern 30 and the outside area (area positioned radially outside the coil pattern 30) of the coil pattern 30. The coil pattern 30 is wound in about two turns, and adjacent turns thereof are insulated by the insulating resin layer 120. The outer peripheral end of the coil pattern 30 is connected to the outer peripheral end of the coil pattern 20 through a via hole 72 formed in the insulating resin layer 120. The connection patterns 31 and 32 are not connected to the coil pattern 30 in the same surface and independent therein and respectively connected to the connection patterns 21 and 22 through via holes 82 and 92 formed in the insulating resin layer 120. The coil pattern 30 and connection pattern 31 are separated from each other through the insulating resin layer 120. On the other hand, the coil pattern 30 and connection pattern 32 are separated from each other not only through the insulating resin layer 120 but also through the magnetic element body 110. In the conductor layer L3, a part of the magnetic element body 110 that separates the coil pattern 30 and connection pattern 32 constitutes a separation area D3.

The conductor layer L4 has a coil pattern 40 and connection patterns 41 and 42. The magnetic element body 110 is disposed, through the insulating resin layer 120, in the inner diameter area (area surrounded by the coil pattern 40) of the coil pattern 40 and the outside area (area positioned radially outside the coil pattern 40) of the coil pattern 40. The coil pattern 40 is wound in about two turns, and adjacent turns thereof are insulated by the insulating resin layer 120. The inner peripheral end of the coil pattern 40 is connected to the inner peripheral end of the coil pattern 30 through a via hole 73 formed in the insulating resin layer 120. The connection patterns 41 and 42 are not connected to the coil pattern 40 in the same surface and independent therein and respectively connected to the connection patterns 31 and 32 through via holes 83 and 93 formed in the insulating resin layer 120. The coil pattern 40 and connection pattern 41 are separated from each other through the insulating resin layer 120. On the other hand, the coil pattern 40 and connection pattern 42 are separated from each other not only through the insulating resin layer 120 but also through the magnetic element body 110. In the conductor layer L4, a part of the magnetic element body 110 that separates the coil pattern 40 and connection pattern 42 constitutes a separation area D4.

The conductor layer L5 has a coil pattern 50 and connection patterns 51 and 52. The magnetic element body 110 is disposed, through the insulating resin layer 120, in the inner diameter area (area surrounded by the coil pattern 50) of the coil pattern 50 and the outside area (area positioned radially outside the coil pattern 50) of the coil pattern 50. The coil pattern 50 is wound in about two turns, and adjacent turns thereof are insulated by the insulating resin layer 120. The outer peripheral end of the coil pattern 50 is connected to the outer peripheral end of the coil pattern 40 through a via hole 74 formed in the insulating resin layer 120. The connection patterns 51 and 52 are not connected to the coil pattern 50 in the same surface and independent therein and respectively connected to the connection patterns 41 and 42 through via holes 84 and 94 formed in the insulating resin layer 120. The coil pattern 50 and connection pattern 51 are separated from each other through the insulating resin layer 120. On the other hand, the coil pattern 50 and connection pattern 52 are separated from each other not only through the insulating resin layer 120 but also through the magnetic element body 110. In the conductor layer L5, a part of the magnetic element body 110 that separates the coil pattern 50 and connection pattern 52 constitutes a separation area D5.

The conductor layer L6 has a coil pattern 60 and connection patterns 61 and 62. The magnetic element body 110 is disposed, through the insulating resin layer 120, in the inner diameter area (area surrounded by the coil pattern 60) of the coil pattern 60 and the outside area (area positioned radially outside the coil pattern 60) of the coil pattern 60. The coil pattern 60 is wound in about 1.5 turns, and adjacent turns thereof are insulated by the insulating resin layer 120. The outer peripheral end of the coil pattern 60 is connected to the connection pattern 62 through a lead-out pattern 63. The inner peripheral end of the coil pattern 60 is connected to the inner peripheral end of the coil pattern 50 through a via hole 75 formed in the insulating resin layer 120. The connection pattern 61 is not connected to the coil pattern 60 in the same surface and independent therein. The connection patterns 61 and 62 are respectively connected to the connection patterns 51 and 52 through via holes 85 and 95 formed in the insulating resin layer 120. The coil pattern 60 and connection pattern 61 are separated from each other not only through the insulating resin layer 120 but also through the magnetic element body 110.

As illustrated in FIG. 1, the connection patterns 11, 21, 31, 41, 51 and 61 overlap one another in a plan view (as viewed in the Z-direction) and are each exposed from two surfaces 111 and 113 of the magnetic element body 110 to constitute one terminal electrode of the coil component 100 according to the present embodiment. The connection patterns 12, 22, 32, 42, 52, and 62 overlap one another in a plan view (as viewed in the Z-direction) and are each exposed from two surfaces 111 and 114 of the magnetic element body 110 to constitute the other terminal electrode of the coil component 100 according to the present embodiment.

The lead-out pattern 63 of the coil pattern 60 positioned in the conductor layer L6 is a part of the coil pattern 60 that is positioned in the vicinity of the outer peripheral end thereof, which extends in the negative Y-direction so as to be separated from the radially inner turn. That is, the lead-out pattern 63 is a part of the coil pattern 60 that is sandwiched by the magnetic element body 110 through the insulating resin layer 120 from both sides in the width direction (X-direction).

The lead-out pattern 63 overlaps the separation areas D1 to D5 of the respective conductor layers L1 to L5 in a plan view (as viewed in the Z-direction). Thus, as compared with a case where the separation areas D1 to D5 are filled with the conductor pattern or insulating resin layer 120, the volume of the magnetic element body 110 positioned in the conductor layers L1 to L5 increases, making it possible to achieve high inductance. The increase in volume of the magnetic element body 110 also reduces leakage flux.

In manufacturing the coil component 100 according to the present embodiment, the insulating resin layer 120 and conductor layers L1 to L6 are alternately stacked in this order, and then the magnetic element body 110 is filled in a space having neither the insulating resin layer 120 nor conductor layers L1 to L6, whereby the coil component 100 is completed. In this case, some kind of foundation for forming the lead-out pattern 63 is required in the conductor layer L5 positioned below the lead-out pattern 63. In this embodiment, a sacrificial pattern is formed in a part corresponding to the separation areas D1 to D5 and used as the foundation for the lead-out pattern 63 (the sacrificial pattern is removed before filling of the magnetic element body 110).

When a composite material containing magnetic fillers and a resin binder is used as the material of the magnetic element body 110, a plurality of kinds of magnetic fillers having different particle size distributions may be blended. This allows small-size magnetic fillers to be efficiently filled in the narrow separation areas D1 to D5. As a result, the average article size of the magnetic fillers to be filled in the separation areas D1 to D5 is smaller than that of the magnetic fillers to be filled in other areas of the magnetic element body 110, hardly generating voids in the separation areas D1 to D5.

As described above, in the coil component 100 according to the present embodiment, the coil pattern 60 positioned in the topmost layer is connected to the connection pattern 62 through the lead-out pattern 63, and the magnetic element body 110 is disposed in the separation areas D1 to D5 that overlap the lead-out pattern 63 in a plan view, thus increasing the volume of the magnetic element body 110, which in turn achieves high inductance.

While some embodiments of the present disclosure has been described, the present disclosure is not limited to the above embodiments, and various modifications may be made within the scope of the present disclosure, and all such modifications are included in the present disclosure.

For example, the magnetic element body 110 is disposed in all the separation areas D1 to D5 in the above embodiment; however, this is not required in the present invention, and it is sufficient that the magnetic element body 110 may be disposed in at least one of the separation areas D1 to D5.

Further, although six conductor layers L1 to L6 are stacked in the above embodiment, the number of the conductor layers is not particularly limited. For example, the number of the conductor layers may be four.

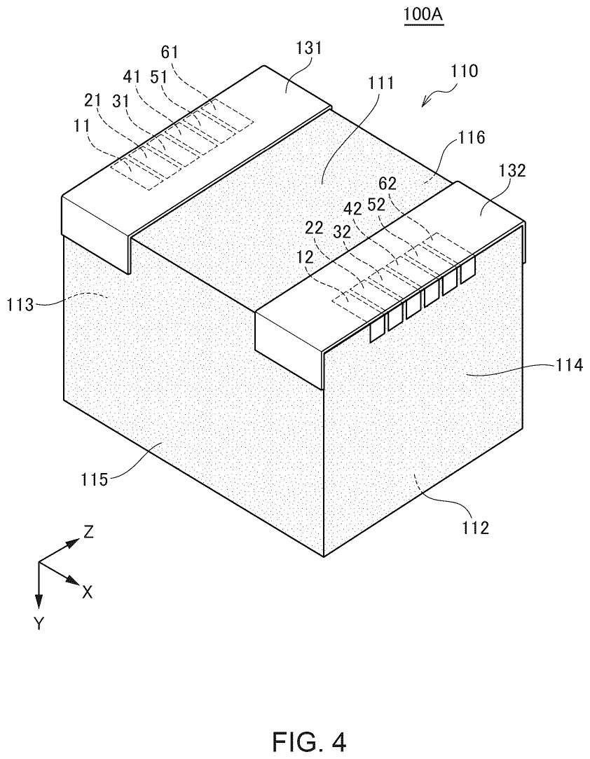

Further, in the above embodiment, the connection patterns 11, 21, 31, 41, 51, and 61 exposed from the surfaces of the magnetic element body 110 are used as one terminal electrode, and the connection patterns 12, 22, 32, 42, 52, and 62 exposed from the surfaces of the magnetic element body 110 are used as the other terminal electrode; however, as in a coil component 100A according to a modification illustrated in FIG. 4, a terminal electrode 131 contacting the connection patterns 11, 21, 31, 41, 51, and 61 and a terminal electrode 132 contacting the connection patterns 12, 22, 32, 42, 52, and 62 may be provided on the surface 111 of the magnetic element body 110. This allows the shape of the terminal electrodes 131 and 132 to be designed as desired.

The technology according to the present disclosure includes the following configuration examples, but not limited thereto.

A coil component according to one aspect of the present disclosure includes: a magnetic element body having a mounting surface and a plurality of conductor layers embedded in the magnetic element body and stacked through insulating resin layers. The plurality of conductor layers each include a coil pattern having a coil axis extending in parallel to the mounting surface and first and second connection patterns exposed from the magnetic element body. The first connection patterns included in the plurality of respective conductor layers overlap one another in a plan view as viewed in the stacking direction, and the second connection patterns included in the plurality of respective conductor layers overlap one another in a plan view as viewed in the stacking direction. The plurality of conductor layers includes a first conductor layer positioned at one end portion in the stacking direction, a second conductor layer positioned at the other end portion in the stacking direction, and one or more third conductor layers positioned between the first and second conductor layers. In the first conductor layer, the outer peripheral end of the coil pattern is connected to the first connection pattern, and the second connection pattern is separated from the coil pattern in the same surface. In the second conductor layer, the outer peripheral end of the coil pattern is connected to the second connection pattern through a lead-out pattern, and the first connection pattern is separated from the coil pattern in the same surface. In the third conductor layer, both the first and second patterns are separated from the coil pattern in the same surface. In at least one of the first to third conductor layers, the magnetic element body is disposed in a separation area overlapping the lead-out pattern in a plan view as viewed in the stacking direction. Thus, inductance is increased due to the presence of the magnetic element body in the separation area.

In the above coil component, the magnetic element body may be disposed in the separation areas positioned in the respective first and third conductor layers. This can further increase the volume of the magnetic element body.

In the above coil component, the magnetic element body may be made of a composite magnetic material containing magnetic fillers and a resin binder, and the average particle size of the magnetic fillers positioned in the separation area may be smaller than that of the magnetic fillers positioned in other areas of the magnetic element body. This hardly generates voids.

The above coil component may further include a first terminal electrode contacting the first connection patterns exposed from the mounting surface and a second terminal electrode contacting the second connection patterns exposed from the mounting surface. This allows the shape of the first and second terminal electrodes to be designed as desired.

What is claimed is:

1. A coil component comprising:
a magnetic element body having a mounting surface; and
a plurality of conductor layers embedded in the magnetic element body and stacked through insulating resin layers,
wherein each of the plurality of conductor layers includes a coil pattern having a coil axis extending in parallel to the mounting surface and first and second connection patterns exposed from the magnetic element body,
wherein the first connection patterns included in the plurality of respective conductor layers overlap one another in a plan view as viewed in a stacking direction,
wherein the second connection patterns included in the plurality of respective conductor layers overlap one another in a plan view as viewed in the stacking direction,
wherein the plurality of conductor layers includes a first conductor layer positioned at one end portion in the stacking direction, a second conductor layer positioned at another end portion in the stacking direction, and one or more third conductor layers positioned between the first and second conductor layers,
wherein, in the first conductor layer, an outer peripheral end of the coil pattern is connected to the first connection pattern, and the second connection pattern is separated from the coil pattern in a same surface,
wherein, in the second conductor layer, an outer peripheral end of the coil pattern is connected to the second connection pattern through a lead-out pattern, and the first connection pattern is separated from the coil pattern in a same surface,
wherein, in the third conductor layer, both the first and second patterns are separated from the coil pattern in the a surface, and
wherein, in at least one of the first to third conductor layers, the magnetic element body is disposed in a separation area overlapping the lead-out pattern in a plan view as viewed in the stacking direction.

2. The coil component as claimed in claim 1, wherein the magnetic element body is disposed in the separation areas positioned in the respective first and third conductor layers.

3. The coil component as claimed in claim 1,
wherein the magnetic element body is made of a composite magnetic material containing magnetic fillers and a resin binder, and
wherein an average particle size of the magnetic fillers positioned in the separation area is smaller than that of the magnetic fillers positioned in other areas of the magnetic element body.

4. The coil component as claimed in claim 1, further comprising:
a first terminal electrode contacting the first connection patterns exposed from the mounting surface; and
a second terminal electrode contacting the second connection patterns exposed from the mounting surface.
